(19) United States
(12) Patent Application Publication
(10) Pub. No.: US 2016/0231974 A1
(43) Pub. Date: Aug. 11, 2016

(54) DUAL IMAGE DISPLAY DEVICE AND DRIVING METHOD THEREOF

(71) Applicant: SAMSUNG DISPLAY CO., LTD., Yongin-City (KR)

(72) Inventor: Yoon Young LEE, Asan-si (KR)

(21) Appl. No.: 14/807,988

(22) Filed: Jul. 24, 2015

(30) Foreign Application Priority Data
Feb. 5, 2015 (KR) 10-2015-0018153

(51) Int. Cl. G06F 3/14; G04C 17/00; G06F 1/16; G04B 19/06; G06F 3/147; G09G 3/00

(52) U.S. Cl. CPC G06F 3/1431; G06F 3/147; G09G 3/001; G06F 1/163; G04B 19/06; G04C 17/0091; G09G 2300/023

(57) ABSTRACT

A dual image display device, including a first screen display; a second screen display overlapping the first screen display and including a transparent display; and a driving controller to control the second screen display, the second screen display selectively transmitting and displaying an image of the first screen display according to control of the driving controller.

### CROSS-REFERENCE TO RELATED APPLICATION

Korean Patent Application No. 10-2015-0018153, filed on Feb. 5, 2015, in the Korean Intellectual Property Office, and entitled: “Dual Image Display Device and Driving Method Thereof,” is incorporated by reference herein in its entirety.

### BACKGROUND

1. Field

The present disclosure relates to a dual image display device including a transparent display and a driving method thereof.

2. Description of the Related Art

With the development of electronic technology, various types of electronic devices may be used. For example, various types of display devices, such as a mobile phone, a tablet PC, and a wearable electrode device, may be used. Game, music, and multimedia content and applications may be useable in the various electronic devices.

### SUMMARY

Embodiments may be realized by providing a dual image display device, including a first screen display; a second screen display overlapping the first screen display and including a transparent display; and a driving controller to control the second screen display, the second screen display selectively transmitting and displaying an image of the first screen display according to control of the driving controller.

The first screen display may display one or more of a clock, global positioning system (GPS) location information, contact information, or health information.

The first screen may display is an organic light emitting device (OLED).

The first screen display may be an analog watch including an hour hand and a minute hand.

The controller may include a first driving mode that allows the image of the first screen display to be transmitted and displayed through the transparent display of the first screen display; and a second driving mode that forms an image on the transparent display such that the image of the second screen display is displayed.

The first driving mode may be an operation off state of the transparent display.

The second driving mode may be an operation on state of the transparent display.

The dual image display device may further include a frame body surrounding edges of the first screen display and the second screen display and simultaneously fixing the first screen display and the second screen display together.

A band portion to be worn on a portion of a user body may be connected to sides of the frame body and may be configured to be worn on a portion of a user body.

The second screen display may be a transparent liquid crystal display (LCD), a transparent thin film electroluminescent panel (TFEL), or a transparent OLED.

A light-transmitting passivation layer may be attached to a surface of the second screen display.

The light-transmitting passivation layer may include a glass or plastic material.

Embodiments may be realized by providing a method for driving a dual image display device, including a first screen display, a second screen display overlapping the first screen display and including a transparent display, and a driving controller to control the second screen display, the second screen display selectively transmitting and displaying an image of the first screen display according to control of the driving controller, the method including allowing the image of the first screen display to be transmitted through the second screen display by making the transparent display transparent; selecting, by the driving controller, a driving mode of the second screen display; and forming an image on the transparent display to display an image of the second screen display.

The controller may produce a first driving mode that allows the image of the first screen display to be transmitted and displayed through the transparent display of the first screen display; and a second driving mode that forms the image on the transparent display such that the image of the second screen display is displayed.

The first driving mode may be an operation off state of the transparent display.

The second driving mode may be an operation on state of the transparent display.

### BRIEF DESCRIPTION OF THE DRAWINGS

Features will become apparent to those of skill in the art by describing in detail exemplary embodiments with reference to the attached drawings in which:

FIG. 1 illustrates a schematic perspective view of a dual image display device according to a first exemplary embodiment; and

FIG. 2 illustrates an exploded schematic perspective view of the dual image display device of FIG. 1;

FIG. 3 illustrates a schematic pixel layout view of an enlarged view of the portion A of FIG. 2;

FIG. 4 illustrates a schematic plan view of a state of a first driving mode of the dual image display device according to the first exemplary embodiment;

FIG. 5 illustrates a schematic plan view of a state of a second driving mode of the dual image display device according to the first exemplary embodiment;

FIG. 6 illustrates a schematic flowchart of a driving method of the dual image display device according to the first exemplary embodiment;

FIG. 7 illustrates an exploded schematic perspective view of a dual image display device according to a second exemplary embodiment;

FIG. 8 illustrates a schematic perspective view of a dual image display device according to a third exemplary embodiment; and

FIG. 9 illustrates an exploded schematic perspective view of the dual image display device of FIG. 8.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

In the present disclosure, the term “on” means that a component is disposed over or under a target portion, and does not necessarily mean that a component is essentially disposed on an upper portion with reference to gravity.

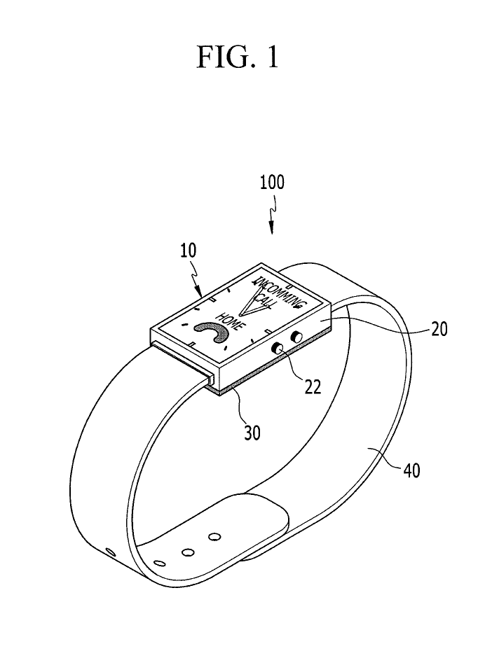

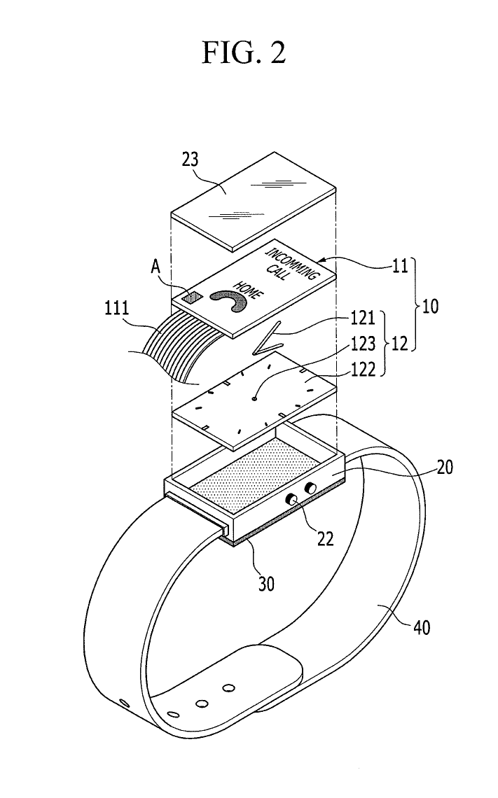

FIG. 1 illustrates a schematic perspective view of a dual image display device, and FIG. 2 illustrates an exploded schematic perspective view of the dual image display device of FIG. 1.

Referring to FIGS. 1 and 2, the dual image display device 100 according to a first exemplary embodiment may include a display unit 10, a frame body 20 in which the display unit 10 may be installed, a driving controller 30 that may control the display unit 10, and a band portion 40 that may be installed in the frame body 20.

The dual image display device 100 which will be described below may be applicable to a watch type of which the display unit 10 may be exposed upward. For example, in the dual image display device 100, the band portion 40 that may be capable of being worn around a user's wrist may be connected to sides of the frame body 20.

The frame body 20 may be formed such that an installation space may be formed inside the frame body 20 and may be formed to have a quadrangle plane such that the display unit 10 may be exposed. In an embodiment, the frame body 20 may not be a quadrangle and may have a rounded edge or edges. A protection glass 23 may be installed in the frame body 20 from protection from external impact. Reference numeral 22 denotes an input terminal portion.

The band portion 40 may extend from both sides of the frame body 20 in a stripe shape. A buckle may be provided at both extending ends of the band portion 40, and it may be possible to fix the dual image display device 100 of the present exemplary embodiment to a user's wrist portion by using the band portion 40.

In an embodiment, the band portion 40 may be fixed to the user's arm in an arm band type. The band portion 40 may be made of an elastic material, or may be made of leather or a flexible plastic material to improve durability.

As described above, the dual image display device 100 may have a watch type through which the user may check a time by using the frame body 20 and the band portion 40. The first screen display unit 12 and the second screen display unit 11 may be sequentially disposed inside the frame body 20. A detailed description thereof will be given below.

The first screen display unit 12 may be installed inside the frame body 20 and may display one or more of a watch, global positioning system (GPS) location information, contact information, or health information.

In the present exemplary embodiment, the first screen display unit 12 may be implemented by using an organic light emitting device (OLED) that may selectively display various images.

In an embodiment, the first screen display unit 12 may be implemented in an analog watch type including hour and minute hands. For example, characteristics or symbols, indicating a time may be displayed in a peripheral portion of the first screen display unit 12. Hour and minute hands 121 which may rotate around an analog watch central portion 123 may be installed on the analog time display unit 122. A second screen display unit 11 may be installed on the first screen display unit 12.

The second screen display unit 11 may be connected to the driving controller 30 by a second flexible circuit board 111, and the second screen display unit 11 may be controlled according to a driving mode selected by, e.g., driving of, the driving controller 30. A detailed description thereof will be given below.

The second screen display unit 11 may be implemented by selectively using a transparent liquid crystal display (LCD), a transparent thin film electroluminescent panel (TFEL), a transparent OLED, and a projection type.

A transparent LCD type screen display device may be implemented by removing a backlight unit from an LCD device and using, for example, a pair of polarizers, an optical film, a transparent thin film transistor, or a transparent electrode. The transparent LCD type screen display device may allow a large area transparent display to be implemented.

The transparent TFEL screen display device may be implemented by using an AC inorganic thin film EL display (AC TFEL) including a transparent electrode, inorganic phosphors, and an insulating layer. The AC TFEL may emit light in such a way that accelerated electrons may pass through the inorganic phosphors to excite phosphors. When the second screen display unit 11 is implemented as a transparent TFEL type, it may be possible to implement a very transparent display second because the inorganic phosphors and the insulating layer may have transparent characteristics.

The transparent OLED screen display device may implement a transparent display device by using a self-emitting OLED.

Since an organic light-emitting layer may be transparent, the transparent OLED screen display device may be implemented as a transparent display device by using both electrodes as transparent electrodes. The OLED may emit light in such a way that electrons and holes may be injected at both sides of an organic emission layer, and may be combined in the organic emission layer. The transparent OLED device may be capable of displaying information by injecting electrons and holes at a desired location by using the principle.

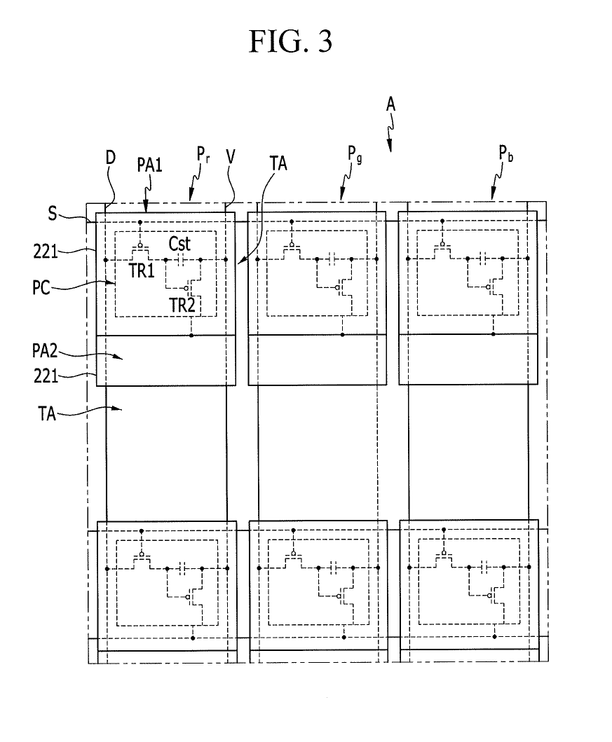

The second display unit 11 according to the present exemplary embodiment will be described with reference to the FIG. 3.

FIG. 3 illustrates a schematic pixel layout view of an enlarged view of the portion A of FIG. 2.

As shown in FIG. 3, each of a red pixel Pr, a green pixel Pg, and a blue pixel Pb may have a first light-emitting region PA1, a second light-emitting region PA2, and a transmitting region TA.

A region A may include a transmitting region TA provided to transmit external light, and a plurality of first light-emitting regions PA1 spaced apart from one another with the light-transmitting region TA interposed therebetween.

In at least a portion of the light-transmitting region TA, a plurality of second light-emitting regions PA2, which may be respectively adjacent to the first light-emitting regions PA1, may be disposed. The second light-emitting region PA2 may be disposed in the light-transmitting region TA with respect to each of pixels Pr, Pg, and Pb, in which transmission of external light and light-emitting both may be possible.

As shown in FIG. 3, a pixel circuit portion may be provided in each of the first light-emitting regions PA1. A plurality of conductive lines, such as a scan line S, a data line D and a Vdd line V, may be electrically connected to the pixel circuit portion PC. The pixel circuit portion (PC) may include a first thin film transistor TR1 that may be connected to the scan line S and the data line D, a second thin film transistor TR2 that may be connected to the first thin film transistor TR1 and the Vdd line V, and a capacitor Cst that may be connected to the first thin film transistor TR1 and the second thin film transistor TR2.

The first thin film transistor TR1 may be a switching transistor and the second thin film transistor TR2 may be a driving transistor. The second thin film transistor TR2 may be electrically connected to a first pixel electrode 221.

As shown in FIG. 3, the scan line S, the data line D, and the Vdd line V may be disposed to overlap the first pixel electrode 221. Although a user may not see a portion of an external image which may be covered by the first light-emitting region PA1, the first light-emitting PA1 may be similar to a configuration in which a plurality of dots may be regularly arranged on a surface of a transparent glass when an entire display region is viewed. Therefore, it may be possible to implement a transparent display because it may not be difficult for the user to see the external image.

Driving modes of the dual image display device according to the first exemplary embodiment as described above will be described below in detail with reference to the drawings.

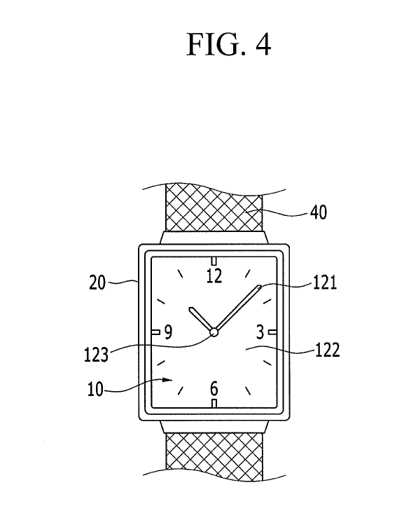

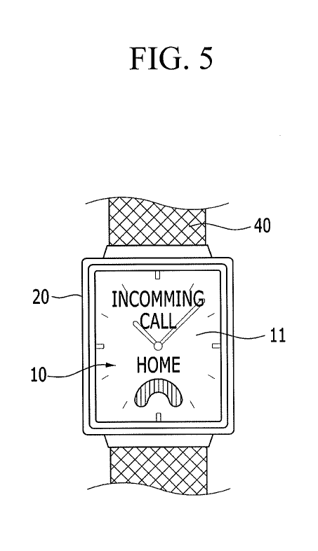

FIG. 4 illustrates a schematic plan view of a state of a first driving mode of the dual image display device according to the first exemplary embodiment, and FIG. 5 illustrates a schematic plan view of a state of a second driving mode of the dual image display device according to the first exemplary embodiment.

First, as shown in FIG. 4, in a first driving mode, when power is applied to the second screen display unit 11, hour and minute hands 121 of the first screen display unit 12 may be rotated around an analog watch central portion 123 on an analog watch display unit 122. Therefore, it may be possible to allow a user to observe a time in an analog scheme since the hour and minute hands 121 may be transmitted through the second screen display unit 11.

Next, as shown in FIG. 5, in a second driving mode, it may be possible to independently operate the second screen display unit 11. The hour and minute hands 121 of the analog watch may be capable of being independently operated, and it may be possible to drive the second screen display unit 11, and simultaneously, allow the hour and minute hands 121 to be transmitted and displayed through the second screen display unit 11. The user may adjust transmittance of the second screen display unit 11, and adjust the transmittance at which the hour and minute hands 121 may be transmitted.

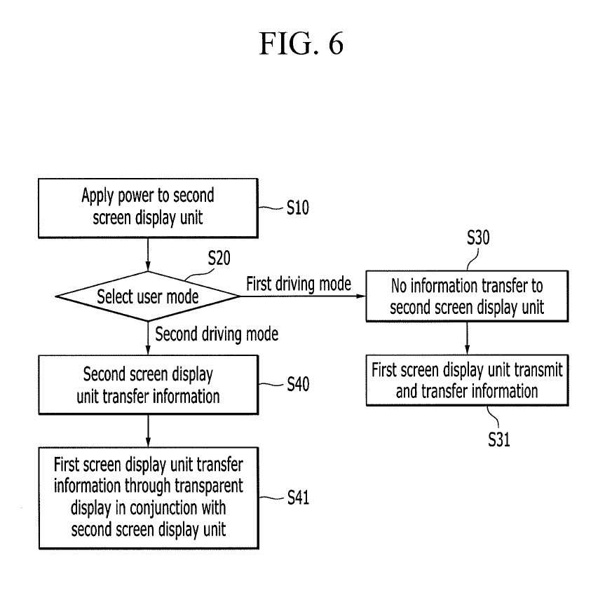

FIG. 6 illustrates a schematic flowchart of a driving method of the dual image display device according to the first exemplary embodiment. The same reference numerals denote the same members having the same functions as FIGS. 1 to 5, and detailed descriptions of the same reference numerals will be omitted below.

First, power may be applied to the second screen display unit in operation S10.

Next, a user may select one user mode of a first driving mode and a second driving mode of a dual image display device in operation S20.

When the user selects the first driving mode, the second screen display unit 11 may not perform information transfer in operation S30. For example, in operation S30, it may be possible to allow a screen of the first screen display unit 12 to be transmitted and displayed by making the transparent display of the second screen display unit 11 transparent in a state in which information of the screen of the first screen display unit 12 may not be transferred, and the first screen display unit 12 may be capable of transmitting and transferring information through the second screen display unit 11 that may be transparent.

Thereafter, the driving controller 30 may select a driving mode of the second screen display unit 11. For example, when the user selects the second driving mode, the driving controller 30 may implement an image on the transparent display, and the second screen display unit 11 may implement a screen and may transfer information in operation S40. The first screen display unit 12 may transmit information through the transparent display and may display the information in conjunction with the second screen display unit 11 in operation S41.

The driving orders of the first driving mode and the second driving mode may be changed according to exemplary embodiments.

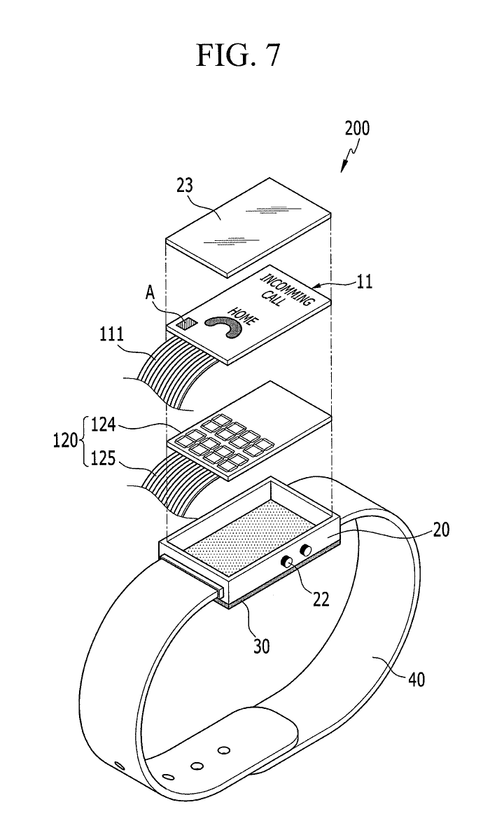

FIG. 7 illustrates an exploded schematic perspective view of a dual image display device according to a second exemplary embodiment. The same reference numerals denote the same members having the same functions as FIGS. 1 to 6, and detailed descriptions of the same reference numerals will be omitted below.

As shown in FIG. 7, the dual image display device 200 according to the second exemplary embodiment may include a first screen display unit 120 which may be implemented by using a liquid crystal display device 124.

The first screen display unit 120 is described as being implemented by using the liquid crystal display device 124 in the present exemplary embodiment. In an embodiment, the first screen display unit 120 may be implemented by using any display device as long as the display device may continuously display a variety of information, such as positioning system (GPS) location information, contact information, and health information.

The first screen display unit 120 may include a first flexible circuit board 125. The first flexible circuit board 125 may be electrically connected to the driving controller 30 along with the second flexible circuit board 111 and may be controlled.

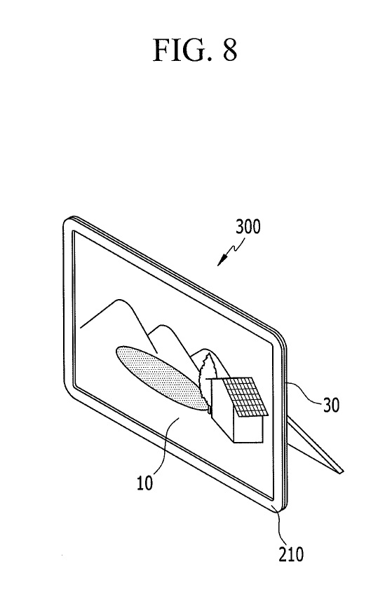

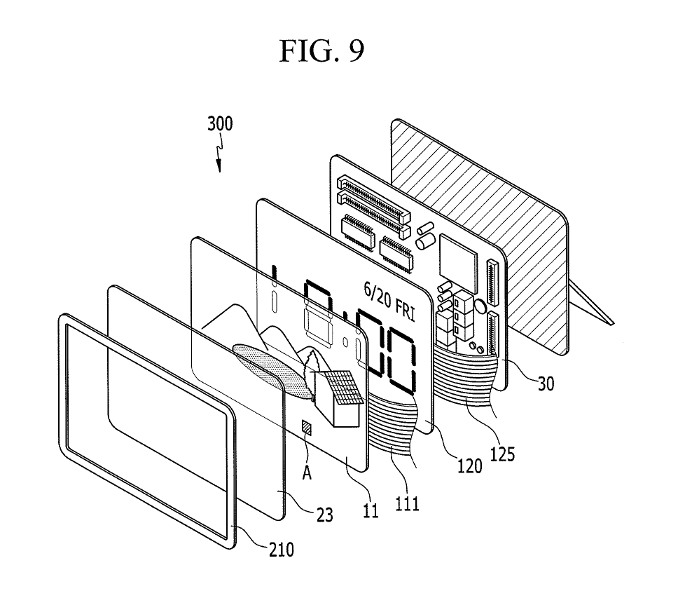

FIG. 8 illustrates an exploded schematic perspective view of a dual image display device according to a third exemplary embodiment, and FIG. 9 illustrates an exploded schematic perspective view of the dual image display device of FIG. 8. The same reference numerals denote the same members having the same functions as FIGS. 1 to 7, and detailed descriptions of the same reference numerals will be omitted below.

As shown in FIGS. 8 and 9, the dual image display device 300 according to the third exemplary embodiment may include a first screen display unit 220 that may be connected to the first flexible circuit boar 125, a second screen display unit 11 that may be connected to the second flexible circuit board 111 and disposed to overlap the first screen display unit 220, a driving controller 30 that may be electrically connected to the fist flexible circuit board 211 and the second flexible circuit board 111, and a holder frame 210 that may be provided to surround a front surface of the first screen display unit and a rear surface of the second screen display unit 11.

As described above, the dual image display device 100 according to the third exemplary embodiment may be a desktop type which may be capable of standing on a plane upon the use thereof. In an embodiment, the dual image display device 100 may be implemented to have a wall-mounted type.

By way of summation and review, a wearable electrode device may include a display having a size of, for example, 1 to 2 inches. A wearable electrode device may have a small size, and may have various functions, such as a GPS tracking technology, a camera function and a phone function.

When a specific signal is input to a sensor unit from the outside in a state in which a screen is turned off, the wearable electronic device may allow the screen to be driven through a controller.

In a wearable electronic device that performs such a function, burn-in may occur in a display device, for example, due to power consumption or degradation of materials, in the case of long-term use, and in a comparative wearable electronic device it may be difficult to provide a variety of information on a screen for a long period of time.

Provided is a dual image display device and a driving method that may prevent occurrence of burn-in, for example, due to degradation, even in the case of long-term use, and which may ensure stable use.

According to an exemplary embodiment, it may be possible to implement an electronic device, such as a smart watch capable of forming a screen for a long period of time without damage, such as degradation, by doubly disposing a screen display unit having functions, such as GPS location information, health information, contact information, and a transparent display.

According to an exemplary embodiment, it may be possible to provide an analog watch type dual image display device, and users that may not prefer or may have difficulty with digital devices, e.g., elderly, may be able to use the dual image display device.

According to an exemplary embodiment, it may be possible to form a screen for a long period of time by continuously driving at least one of the first screen display unit and the second screen display unit which are overlapped doubly.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A dual image display device, comprising:
a first screen display;
a second screen display overlapping the first screen display and including a transparent display; and
a driving controller to control the second screen display,
the second screen display selectively transmitting and displaying an image of the first screen display according to control of the driving controller.

2. The dual image display device as claimed in claim 1, wherein the first screen display displays one or more of a clock, global positioning system (GPS) location information, contact information, or health information.

3. The dual image display device as claimed in claim 2, wherein the first screen display is an organic light emitting device (OLED).

4. The dual image display device as claimed in claim 2, wherein the first screen display is an analog watch including an hour hand and a minute hand.

5. The method as claimed in claim 4, wherein the controller includes:
a first driving mode that allows the image of the first screen display to be transmitted and displayed through the transparent display of the first screen display; and
a second driving mode that forms an image on the transparent display such that the image of the second screen display is displayed.

6. The method as claimed in claim 5, wherein the first driving mode is an operation off state of the transparent display.

7. The method as claimed in claim 5, wherein the second driving mode is an operation on state of the transparent display.

8. The dual image display device as claimed in claim 1, further comprising a frame body surrounding edges of the first screen display and the second screen display and simultaneously fixing the first screen display and the second screen display together.

9. The dual image display device as claimed in claim 8, wherein a band portion to be worn on a portion of a user body is connected to sides of the frame body.

10. The dual image display device as claimed in claim 1, wherein the second screen display is a transparent liquid crystal display (LCD), a transparent thin film electroluminescent panel (TFEL), or a transparent OLED.

11. The dual image display device as claimed in claim 1, wherein a light-transmitting passivation layer is attached to a surface of the second screen display.

12. The dual image display device as claimed in claim 11, wherein the light-transmitting passivation layer includes a glass or plastic material.

13. A method for driving a dual image display device, including a first screen display, a second screen display overlapping the first screen display and including a transparent display, and a driving controller to control the second screen display, the second screen display selectively transmitting and displaying an image of the first screen display according to control of the driving controller, the method comprising:
allowing the image of the first screen display to be transmitted through the second screen display by making the transparent display transparent;
selecting, by the driving controller, a driving mode of the second screen display; and
forming an image on the transparent display to display an image of the second screen display.

14. The method as claimed in claim 13, wherein the controller produces:
a first driving mode that allows the image of the first screen display to be transmitted and displayed through the transparent display of the first screen display; and
a second driving mode that forms the image on the transparent display such that the image of the second screen display is displayed.

15. The method as claimed in claim 14, wherein the first driving mode is an operation off state of the transparent display.

16. The method as claimed in claim 14, wherein the second driving mode is an operation on state of the transparent display.
